(19) United States
(12) Patent Application Publication
(10) Pub. No.: US 2024/0195078 A1
(43) Pub. Date: Jun. 13, 2024

(54) RADIO WAVE ABSORBING ELEMENT AND ASSEMBLY

(71) Applicant: KYOCERA CORPORATION, Kyoto-shi, Kyoto (JP)

(72) Inventor: Hiromichi YOSHIKAWA, Yokohama-shi, Kanagawa (JP)

(21) Appl. No.: 18/553,842

(22) PCT Filed: Dec. 10, 2021
(86) PCT No.: PCT/JP2021/045704

§ 371 Date: Oct. 4, 2023

(30) Foreign Application Priority Data
Apr. 19, 2021 (JP) 2021-070375

(51) Int. Cl. H01Q 17/00

(52) U.S. Cl. CPC H01Q 17/00

(57) ABSTRACT

A radio wave absorbing element includes a first resonator extending in a first plane direction, a second resonator spaced apart from the first resonator in a first direction and extending in the first plane direction, a third resonator located between the first resonator and the second resonator in the first direction and configured to magnetically or capacitively connect to or electrically connect to each of the first resonator and the second resonator, a reference conductor extending in the first plane direction, located between the first resonator and the second resonator in the first direction, and serving as a potential reference of the first resonator and the second resonator, and a shielding conductor spaced apart from the second resonator in the first direction and extending in the first plane direction.

### TECHNICAL FIELD

The present disclosure relates to a radio wave absorbing element and an assembly.

### BACKGROUND OF INVENTION

A known technique involves controlling electromagnetic waves without using a dielectric lens. For example, Patent Document 1 describes a technique of absorbing radio waves in a structure including an array of resonator elements.

### CITATION LIST

### Patent Literature

Patent Document 1: JP 61-88591 A

### SUMMARY

### Summary of the Invention

The resonator element described in Patent Document 1 includes an impedance conversion layer and thus has a problem of having a large thickness.

The present disclosure provides a radio wave absorbing element and an assembly configured to shield electromagnetic waves in a predetermined frequency band.

### Solution to Problem

A radio wave absorbing element according the present disclosure includes a first resonator extending in a first plane direction, a second resonator spaced apart from the first resonator in a first direction and extending in the first plane direction, a third resonator located between the first resonator and the second resonator in the first direction and configured to magnetically or capacitively connect to or electrically connect to each of the first resonator and the second resonator, a reference conductor extending in the first plane direction, located between the first resonator and the second resonator in the first direction, and serving as a potential reference of the first resonator and the second resonator, and a shielding conductor spaced apart from the second resonator in the first direction and extending in the first plane direction, in which the reference conductor surrounds at least a part of the third resonator in the first plane direction.

An assembly according to the present disclosure includes a plurality of the radio wave absorbing elements according to the present disclosure, and the plurality of radio wave absorbing elements are arranged in the first plane direction.

### Advantageous Effect

According to the present disclosure, electromagnetic waves in a predetermined frequency band can be shielded.

### BRIEF DESCRIPTION OF THE DRAWINGS

FIG. 1 is a diagram illustrating an overview of an assembly according to an embodiment.

FIG. 2 is a diagram schematically illustrating a configuration of a unit structure according to the embodiment.

FIG. 3 is a graph showing frequency characteristics of the unit structure according to the embodiment.

### DESCRIPTION OF EMBODIMENTS

Embodiments of the present disclosure will be described in detail with reference to the drawings. The embodiments described below do not limit the present disclosure.

In the following description, an XYZ orthogonal coordinate system is set, and the positional relationship between respective portions will be described by referring to the XYZ orthogonal coordinate system. A direction parallel to an X-axis in a horizontal plane is defined as an X-axis direction, a direction parallel to a Y-axis orthogonal to the X-axis in the horizontal plane is defined as a Y-axis direction, and a direction parallel to a Z-axis orthogonal to the horizontal plane is defined as a Z-axis direction. A plane including the X-axis and the Y-axis is appropriately referred to as an XY plane, a plane including the X-axis and the Z-axis is appropriately referred to as an XZ plane, and a plane including the Y-axis and the Z-axis is appropriately referred to as a YZ plane. The XY plane is parallel to the horizontal plane. The XY plane, the XZ plane, and the YZ plane are orthogonal to each other.

### Overview

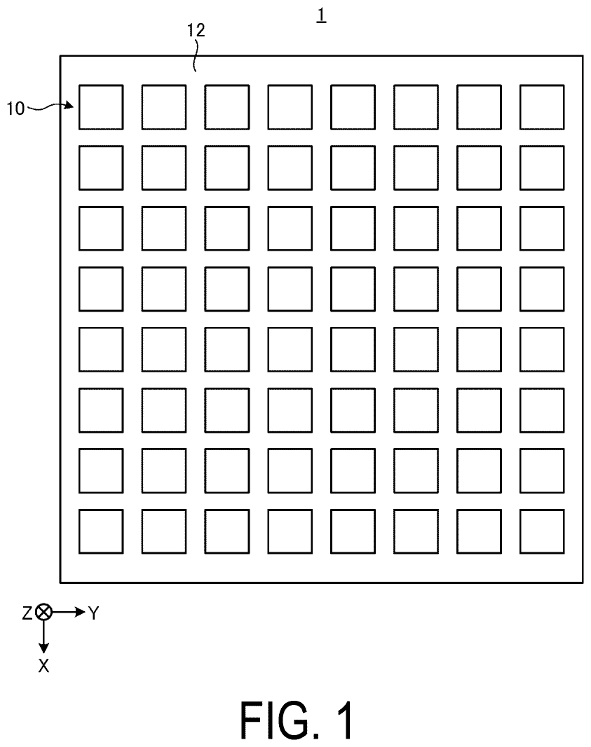

FIG. 1 illustrates an assembly in which a plurality of unit structures are periodically arranged. In the assembly, the plurality of unit structures periodically arranged function as an assembly. For example, the assembly can function as a radio wave absorbing plate shielding radio waves in a predetermined frequency band.

As illustrated in FIG. 1, an assembly 1 includes a plurality of unit structures 10 and a substrate 12.

The plurality of unit structures 10 are arranged in an XY plane direction. The XY plane direction may also be referred to as a first plane direction. That is, the plurality of unit structures 10 are arranged two-dimensionally. Each of the plurality of unit structures 10 has a structure shielding the radio waves. The structure of the unit structure 10 will be described later. The unit structure 10 may be referred to as a radio wave absorbing element. The substrate 12 may be, for example, a dielectric substrate made of a dielectric body. The assembly 1 is made by two-dimensionally arranging the plurality of unit structures 10 on the substrate 12 made of the dielectric body.

In the present disclosure, the assembly can be configured by arranging the unit structures of the following embodiment as illustrated in FIG. 1.

### EMBODIMENT

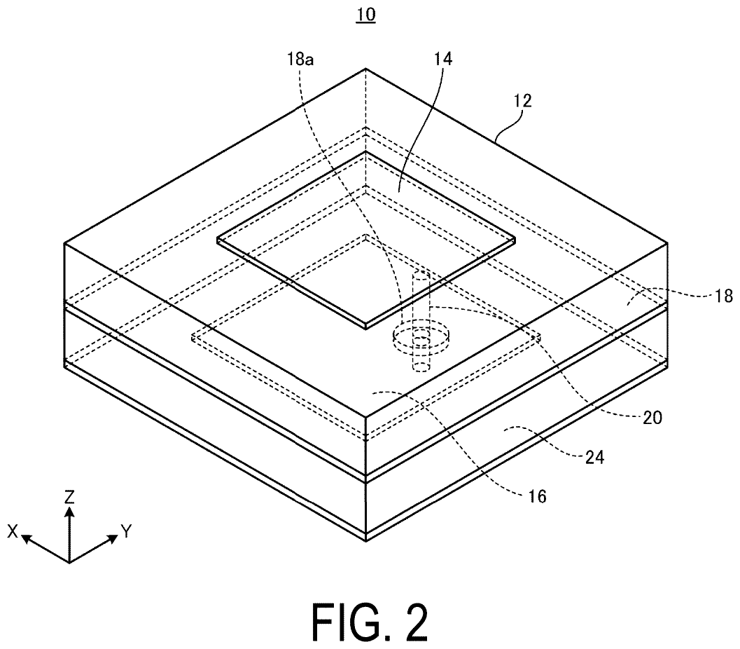

A configuration of the unit structure according to the embodiment will be described with reference to FIG. 2. FIG. 2 is a diagram illustrating the configuration of the unit structure according to the embodiment.

As illustrated in FIG. 2, the unit structure 10 includes the substrate 12, a first resonator 14, a second resonator 16, a reference conductor 18, a connection line path 20, and a shielding conductor 24.

The first resonator 14 may be arranged on the substrate 12, extending on the XY plane. The first resonator 14 may be made of a conductor. The first resonator 14 may be, for example, a patch conductor formed in a rectangular shape. In the example illustrated in FIG. 2, the first resonator 14 is illustrated as the rectangular patch conductor, but the present disclosure is not limited thereto. The first resonator 14 may have, for example, a linear shape, a circular shape, a loop shape, or a polygonal shape other than a rectangular shape. That is, the shape of the first resonator 14 may be arbitrarily changed according to the design. The first resonator 14 resonates by an electromagnetic wave received from the +Z-axis direction.

The first resonator 14 radiates an electromagnetic wave during resonance. The first resonator 14 radiates the electromagnetic wave to the +Z-axis direction side during resonance.

The second resonator 16 may be arranged on the substrate 12 to extend on the XY plane at a position away from the first resonator 14 in the Z-axis direction. The second resonator 16 may be, for example, a patch conductor formed in a rectangular shape. In the example illustrated in FIG. 2, the second resonator 16 is illustrated as the rectangular patch conductor, but the present disclosure is not limited thereto. The second resonator 16 may have, for example, a linear shape, a circular shape, a loop shape, or a polygonal shape other than a rectangular shape. That is, the shape of the second resonator 16 may be arbitrarily changed according to the design. The shape of the second resonator 16 may be the same as or different from the shape of the first resonator 14. The area of the second resonator 16 may be the same as or different from the area of the first resonator 14.

The second resonator 16 radiates an electromagnetic wave during resonance. The second resonator 16, for example, radiates the electromagnetic wave to the −Z-axis direction side. The second resonator 16 radiates the electromagnetic wave to the −Z-axis direction side during resonance. The second resonator 16 resonates by receiving the electromagnetic wave from the −Z-axis direction.

The second resonator 16 may resonate at a phase different from that of the first resonator 14. The second resonator 16 may resonate in a direction different from the first resonator 14 in the XY plane direction. For example, when the first resonator 14 resonates in the X-axis direction, the second resonator 16 may resonate in the Y-axis direction. The resonance direction of the second resonator 16 may change with time in the XY plane direction corresponding to a change with time in the resonance direction of the first resonator 14. The second resonator 16 may radiate the electromagnetic wave received by the first resonator 14 with a first frequency band thereof attenuated.

The reference conductor 18 may be arranged between the first resonator 14 and the second resonator 16 in the substrate 12. The reference conductor 18 may be, for example, at the center between the first resonator 14 and the second resonator 16 in the substrate 12, but the present disclosure is not limited thereto. For example, the reference conductor 18 may be at a position where the distance from the reference conductor 18 to the first resonator 14 differs from the distance from the reference conductor 18 to the second resonator 16. The reference conductor 18 has a through-hole 18a through which the connection line path 20 extends. The reference conductor 18 surrounds at least a part of the connection line path 20.

The connection line path 20 may be made of a conductor. The connection line path 20 is located between the first resonator 14 and the second resonator 16 in the Z-axis direction. The Z-axis direction may also be referred to as a first direction, for example. The connection line path 20 may be connected to each of the first resonator 14 and the second resonator 16. Although the connection line path 20 passes through the through-hole 18a, the connection line path 20 is not in contact with the reference conductor 18. The connection line path 20 may be magnetically or capacitively connected to each of the first resonator 14 and the second resonator 16, for example. For example, the connection line path 20 may be electrically connected to each of the first resonator 14 and the second resonator 16. The connection line path 20 is connected to a side of the first resonator 14 parallel to the X-axis direction and is connected to a side of the second resonator 16 parallel to the X-axis direction. The connection line path 20 may be a path parallel to the Z-axis direction. The connection line path 20 may be a third resonator.

The shielding conductor 24 is made of a conductor. The shielding conductor 24 is arranged below the second resonator 16 in the Z-axis direction. The shielding conductor 24 is arranged to receive the electromagnetic wave radiated from the second resonator 16. The shielding conductor 24 is arranged such that the electromagnetic wave incident on the first resonator 14 is not radiated from the unit structure 10. In other words, the shielding conductor 24 shields the electromagnetic wave received by the first resonator 14. The shielding conductor 24 shields the electromagnetic wave radiated by the second resonator 16.

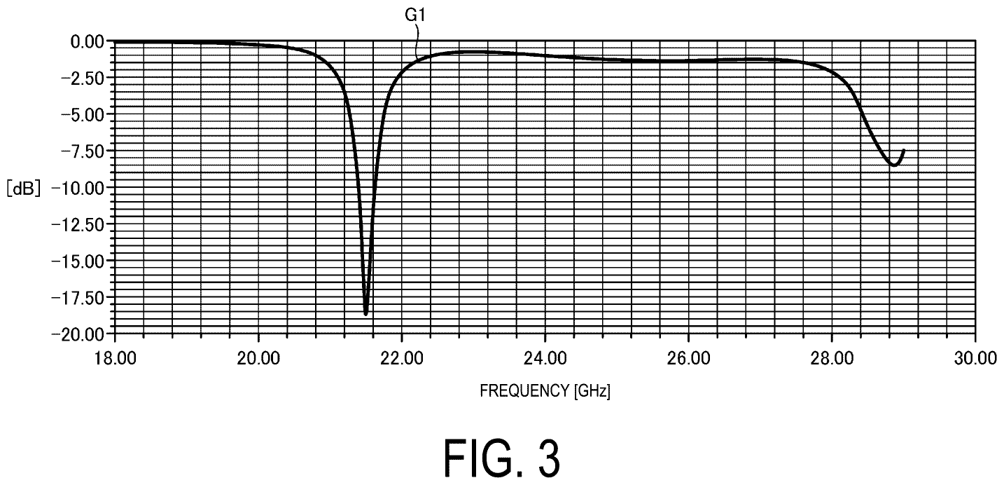

Frequency characteristics of the unit structure according to the embodiment will be described with reference to FIG. 3. FIG. 3 is a graph showing the frequency characteristics of the unit structure according to the embodiment.

In FIG. 3, the horizontal axis represents the frequency [Giga Hertz (GHz)] and the vertical axis represents the gain [deci Bel (dB)]. FIG. 3 shows a graph G1. The graph G1 shows a reflection coefficient. As shown in graph G1, the unit structure 10 has an insertion loss of −2.50 dB or more in a range from around 18.00 GHz to around 28.00 GHz. The unit structure 10 has an insertion loss of −17.50 dB or less in a range around 21.50 GHz. The unit structure 10 does not transmit the electromagnetic wave in a frequency band around 21.50 GHz. That is, the unit structure 10 does not transmit the electromagnetic wave in a specific frequency band. The unit structure 10 can shield the electromagnetic wave at the specific frequency. The frequency to be shielded against can be changed according to the resonant frequency of the unit structure 10.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1 Assembly
10 Unit structure
12 Substrate
14 First resonator
16 Second resonator
18 Reference conductor
20 Connection line path
22 Third resonator
24 Shielding conductor

1. A radio wave absorbing element comprising:
a first resonator extending in a first plane direction;
a second resonator spaced apart from the first resonator in a first direction and extending in the first plane direction;
a third resonator located between the first resonator and the second resonator in the first direction and configured to magnetically or capacitively connect to or electrically connect to each of the first resonator and the second resonator;
a reference conductor extending in the first plane direction, located between the first resonator and the second resonator in the first direction, and serving as a potential reference of the first resonator and the second resonator; and
a shielding conductor spaced apart from the second resonator in the first direction and extending in the first plane direction, wherein
the reference conductor surrounds at least a part of the third resonator in the first plane direction.

2. The radio wave absorbing element according to claim 1, wherein
the shielding conductor is configured to shield an electromagnetic wave received by the first resonator.

3. The radio wave absorbing element according to claim 1, wherein
the shielding conductor is configured to shield the electromagnetic wave radiated by the second resonator.

4. An assembly comprising:
a plurality of the radio wave absorbing elements according to claim 1, wherein
the plurality of radio wave absorbing elements are arranged in the first plane direction.
